(19) United States
(12) Patent Application Publication
(10) Pub. No.: US 2013/0326539 A1
(43) Pub. Date: Dec. 5, 2013

(54) SEMICONDUCTOR DEVICE

(71) Applicants: Sugako Otani, Kawasaki-shi (JP); Hiroyuki Kondo, Kawasaki-shi (JP)

(72) Inventors: Sugako Otani, Kawasaki-shi (JP); Hiroyuki Kondo, Kawasaki-shi (JP)

(73) Assignee: RENESAS ELECTRONICS CORPORATION, Kawasaki-shi (JP)

(21) Appl. No.: 14/000,188

(22) PCT Filed: Feb. 20, 2012
(86) PCT No.: PCT/JP2012/053927

§ 371 Date: Aug. 16, 2013

(30) Foreign Application Priority Data
Mar. 24, 2011 (JP) 2011-066093

(51) Int. Cl. G06F 9/54

(52) U.S. Cl. CPC G06F 9/54
USPC 719/313

(57) ABSTRACT

A semiconductor device includes first and second central processing units (0, 3) and a set of monitoring registers (60) provided inside or outside the second central processing unit (3). Information representing an internal state of the first central processing unit (0) is transferred from the first central processing unit (0) to the set of monitoring registers (60) during execution of a program, and the set of monitoring registers (60) holds such transferred information. The set of monitoring registers (60) is mapped in a memory space of the second central processing unit (3).

### TECHNICAL FIELD

This invention relates to a semiconductor device on which a plurality of central processing units are mounted.

### BACKGROUND ART

In order to make development of software more efficient, many central processing units (CPUs) have an on-chip debugging function complying with JTAG (Joint Test Action Group) specifications or the like. The on-chip debugging function is a function for operating a CPU by inputting a command code through a dedicated interface and extracting resource information within a semiconductor chip. The on-chip debugging function includes a break function capable of stopping execution of a user program at a desired portion, a trace function capable of obtaining information on an internal bus at any time point during execution of a user program, and the like.

According to the technique described in Japanese Patent Laying-Open No. 2001-350648 (PTD 1), a microcomputer provided with the on-chip debugging function described above is further provided with an internal state output circuit for externally outputting prescribed internal state information during execution of a user program and a terminal for outputting the internal state information.

Japanese Patent Laying-Open No. 6-214819 (PTD 2) also includes the description similar to the document above. Specifically, a microcomputer described in this document is provided with an output circuit for externally outputting contents in an execute program counter and selecting a signal or the like input and output between a CPU and a functional module and externally outputting the same.

In recent years, in order to realize a low-power and high-performance system, a multi-processor in which a plurality of CPUs are mounted on the same LSI (Large Scale Integration) (a multi-core processor) has been developed. Debugging of a system on which a plurality of CPUs are mounted presents a new problem which is different from that in a system on which a single CPU is mounted.

For example, in debugging of a system on which a plurality of CPUs are mounted, break, step execution, trace, and the like are carried out for each CPU. Therefore, for efficient debugging, it is necessary to operate break and step execution of each CPU in coordination with each other and to know temporal relation of trace data of each CPU. Japanese Patent Laying-Open No. 2003-162426 (PTD 3) describes a computer system including a control circuit for this purpose.

A method of connecting a set of debugging terminals and a plurality of CPUs to one another is also a problem specific to a multi-processor. According to Ueda et al. (NPD 1), when debugging using a JTAG interface is assumed, four types of methods of connection between a JTAG port and each CPU core to be controlled are considered. Namely, there are an option between cascade connection or parallel switch connection and an option of having a function or the like for synchronization between CPU cores or not having the same. For example, Japanese Patent Laying-Open No. 2004-164367 (PTD 4) discloses a technique for connecting a set of debugging terminals and a selected CPU to each other through a switch circuit (a selecting circuit) with a simplified configuration using a register.

Japanese Patent Laying-Open No. 2009-193305 (PTD 5) discloses a technique capable of addressing a case where, in a multi-core LSI over which a plurality of CPUs are mounted on the same LSI, a certain CPU runs out of control to cause a shared bus to hang up while other CPUs are running normally. Specifically, the multi-core LSI in this document includes a plurality of CPUs coupled to a first shared bus, one or more modules coupled to a second shared bus, a shared bus controller coupled between the first shared bus and the second shared bus, for arbitrating an access to the module(s) by the CPUs, and a system controller that monitors whether or not a response signal to an access request signal of the CPU is output from the module to be accessed. The system controller outputs a pseudo response signal to the first shared bus via the shared bus controller to terminate the access by the CPU while accessing if the response signal is not output from the module to be accessed after the access request signal is output to the second shared bus from the shared bus controller and before a predetermined time elapses.

### CITATION LIST

### Patent Document

PTD 1: Japanese Patent Laying-Open No. 2001-350648

PTD 2: Japanese Patent Laying-Open No. 6-214819

PTD 3: Japanese Patent Laying-Open No. 2003-162426

PTD 4: Japanese Patent Laying-Open No. 2004-164367

PTD 5: Japanese Patent Laying-Open No. 2009-193305

### Non Patent Document

NPD 1: Ueda et al., “Virtualization Technique Supporting Debugging in Linux™ and Multi-Core Environments,” Nikkei Electronics, Jan. 2, 2006, pp. 115-122

### SUMMARY OF INVENTION

### Technical Problem

When a CPU has hung up for some reason, internal information of the hung up CPU cannot be extracted with the on-chip debugging function. Therefore, it becomes difficult to specify a location in a hung-up program.

In particular, in a case of a multi-processor on which a plurality of CPUs are mounted, debugging is more difficult than in a case of a single processor. The reason for this is that, in a multi-processor, task allocation changes each time and hence reproducibility of occurrence of hang-up is low; for example, hang-up occurs in a CPU different for each time of execution of a program. In addition, in a multi-processor, resource competition is likely because of access from each CPU or an amount of debugging is also great because a large-scale program is handled, which also makes debugging more difficult.

In a case of a single processor, a trace function is made use of in order to facilitate debugging in case of hang-up. In a case of a multi-processor, however, it is difficult to provide a trace function equivalent to that for a single processor with all processors, due to restriction imposed by a circuit size or a terminal.

Though Japanese Patent Laying-Open No. 2003-162426 (PTD 3) and Japanese Patent Laying-Open No. 2004-164367 (PTD 4) above aim to facilitate debugging of a multi-processor, they do not mention a case where a CPU has hung up. Though Japanese Patent Laying-Open No. 2009-193305 (PTD 5) is directed to an invention in connection with a case where a CPU has hung up, it focuses on elimination of hang-up and does not provide means for facilitating debugging.

Therefore, an object of this invention is to provide a semiconductor device on which a plurality of central processing units (CPUs) are mounted, capable of achieving debugging more readily than in a conventional example when any CPU has hung up.

### Solution to Problem

A semiconductor device according to one embodiment of this invention includes first and second central processing units and a set of monitoring registers provided inside or outside of the second central processing unit. Information representing an internal state of the first central processing unit is transferred from the first central processing unit to the set of monitoring registers during execution of a program and the set of monitoring registers holds such transferred information. The set of monitoring registers is mapped in a memory space of the second central processing unit.

### Advantageous Effects of Invention

According to the embodiment above, when the first central processing unit has hung up, the second central processing unit can be used to obtain an internal state of the first central processing unit, and hence debugging can be carried out more readily than in the conventional example.

### BRIEF DESCRIPTION OF DRAWINGS

FIG. 1 is a block diagram showing a configuration of a microcomputer chip 100 according to a first embodiment of this invention.

FIG. 2 is a circuit diagram showing one example of hardware used for transferring internal information of a CPU 0 shown in FIG. 1.

FIG. 3 is a conceptual diagram for illustrating signal transmission between CPU cores in a microcomputer chip including 4 CPUs.

FIG. 4 is a list of a set of monitoring registers provided in a CPU 3.

FIG. 5 is a diagram for illustrating each monitoring register in FIG. 4.

FIG. 6 is a diagram showing one example of an address map of CPU 3 in FIG. 1.

FIG. 7 is a diagram for illustrating an on-chip debugging method in a case where CPU 0 has not hung up.

FIG. 8 is a diagram for illustrating an on-chip debugging method in a case where CPU 0 has hung up.

FIG. 9 is a diagram showing an example where a path for reading an internal state of each CPU in a microcomputer chip including 4 CPUs is in a ring configuration.

FIG. 10 is a diagram showing an example where a path for reading an internal state of each CPU in a microcomputer chip including 4 CPUs is in a bus configuration.

FIG. 11 is a diagram showing an example where a path for reading an internal state of each CPU in a microcomputer chip including 7 CPUs is in a tree configuration.

### DESCRIPTION OF EMBODIMENTS

An embodiment of this invention will be described hereinafter in detail with reference to the drawings. It is noted that the same or corresponding elements have the same reference characters allotted and description thereof will not be repeated.

<First Embodiment>

[Configuration of Microcomputer Chip]

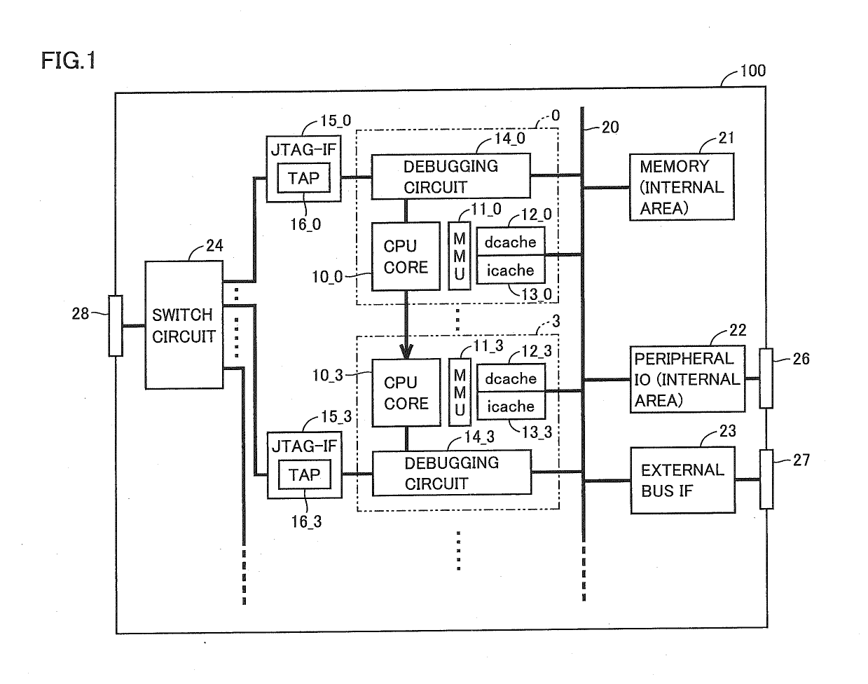

FIG. 1 is a block diagram showing a configuration of a microcomputer chip 100 according to a first embodiment of this invention. Referring to FIG. 1, microcomputer chip 100 includes a plurality of central processing units (CPUs), an internal memory 21, an input and output interface (peripheral IO) 22 for connecting microcomputer chip 100 to peripheral devices, and an external bus interface 23. These elements are connected to one another through an internal bus 20. It is noted that FIG. 1 shows as a representative, a CPU 0 and a CPU 3 among a plurality of CPUs provided in microcomputer chip 100.

Input and output interface 22 is connected to peripheral devices provided outside microcomputer chip 100 through an input and output port 26.

External bus interface 23 is connected to an external memory (such as a DRAM (Dynamic Random Access Memory)), an ASIC (Application Specific Integrated Circuit), and the like provided outside microcomputer chip 100 through an input and output port 27.

CPU 0 includes a core circuit (CPU core) 10_0, a memory management unit (MMU) 11_0, a primary cache (a command cache (icache) 13_0 and a data cache (dcache) 12_0), and a debugging circuit 14_0. Core circuit 10_0 is a core portion of a CPU executing a program stored in internal memory 21 or an external memory.

Memory management unit 11_0 converts between a virtual address and a physical address. The primary cache serves for data access at a higher speed as a result of transfer of data in a part of a memory. Debugging circuit 14_0 is a dedicated circuit provided within a processor for realizing on-board debugging by JTAG ICE (In-circuit Emulator).

Similarly to CPU 0, CPU 3 also includes a core circuit 10_3, an MMU 11_3, a primary cache (12_3, 13_3), and a debugging circuit 14_3. It is noted that, as will be described later, core circuit 10_3 of CPU 3 is provided with a set of monitoring registers to which information on an internal state of CPU 0 is transferred during execution of a program. The set of monitoring registers is mapped in a memory space of CPU 3. Namely, an address is allocated to each register constituting the set of monitoring registers. By issuing a read command describing this allocated address as an operand address to CPU 3, contents held in the set of monitoring registers can be read.

Microcomputer chip 100 further includes a JTAG interface 15 provided in correspondence with each of the plurality of CPUs, a switch circuit 24, and a JTAG port 28. FIG. 1 representatively shows JTAG interfaces 15_0, 15_3 corresponding to CPUs 0, 3, respectively.

Each JTAG interface 15 has a dedicated controller called a TAP (Test Access Port) 16, and communication between a corresponding CPU and an external debugging device connected to JTAG port 28 is established through the TAP. JTAG interface 15 complies with specifications allowing only a specific TAP to communicate with an external debugging device. Switch circuit 24 switches connection between JTAG port 28 and each JTAG interface 15.

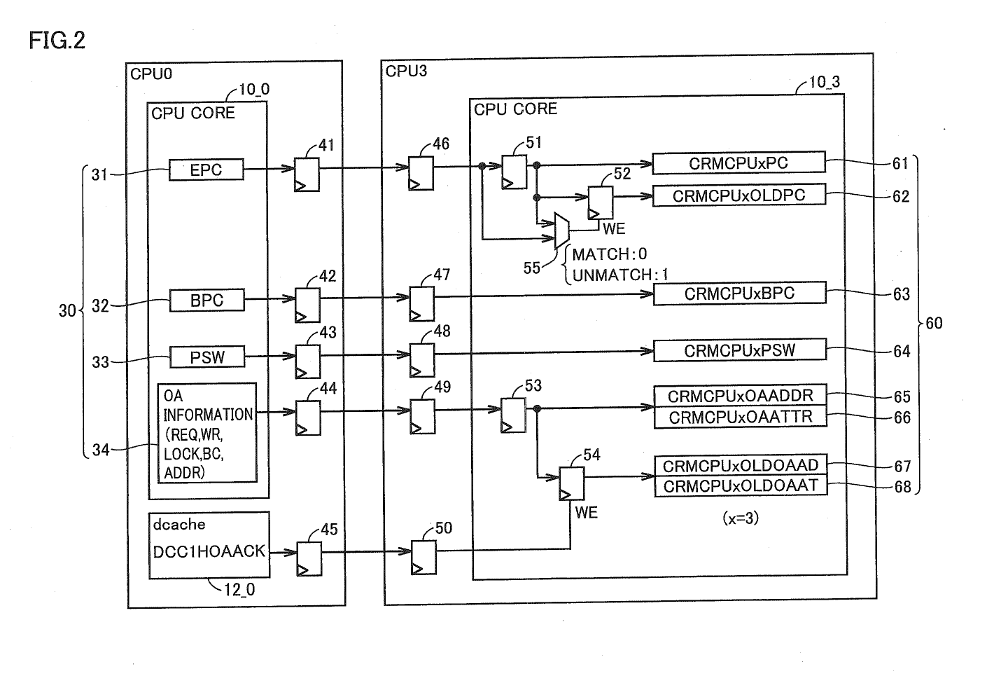

FIG. 2 is a circuit diagram showing one example of hardware used for transferring internal information of CPU 0 shown in FIG. 1.

Referring to FIG. 2, during execution of a program, internal information of CPU 0 is transferred to a set of monitoring registers 60 provided in core circuit 10_3 of CPU 3. Set of monitoring registers 60 is mapped in a memory space of CPU 3. The transferred internal state of CPU 0 is represented, for example, by a value of a set of special registers 30 such as an execute program counter used during execution of a program, and it is information corresponding to a CPU context saved at the time of an interrupt operation.

In a case of the first embodiment, as shown in FIG. 2, a value of an execute program counter (EPC, also simply denoted as PC) 31, a value of a backup program counter (BPC) 32, a value of a program status word (PSW) 33, information 34 on an operand access (OA), or the like is transferred to set of monitoring registers 60. Information on the operand access includes an operand access request (REQ), a write and read attribute (WR), a bus lock request attribute (LOCK), a byte control (BC), operand address information (ADDR), a bus acknowledge signal (DCC1HOAACK) to an operand access request, and the like. In a case of this embodiment, for reasons in terms of a bus configuration, a bus acknowledge signal (DCC1HOAACK) is output by data cache 12_0. It is noted that BPC 32 saves a value of PC when interrupt, trap, or exception occurs.

Though not illustrated in FIG. 2, internal information of memory management unit 11_0 in FIG. 1, that is, TLB (Translation Look-aside Buffer) entry (information on a physical address brought in correspondence with a virtual address) is also desirably transferred to set of monitoring registers 60.

The internal information of CPU 0 to be transferred is transferred to the set of monitoring registers through a plurality of flip-flops (holding circuits) in consideration of latency (delay time). In the case of FIG. 2, flip-flops 41 to 45 are provided in CPU 0 which is an information output side, and flip-flops 46 to 54 are provided in CPU 3 which is an information reception side.

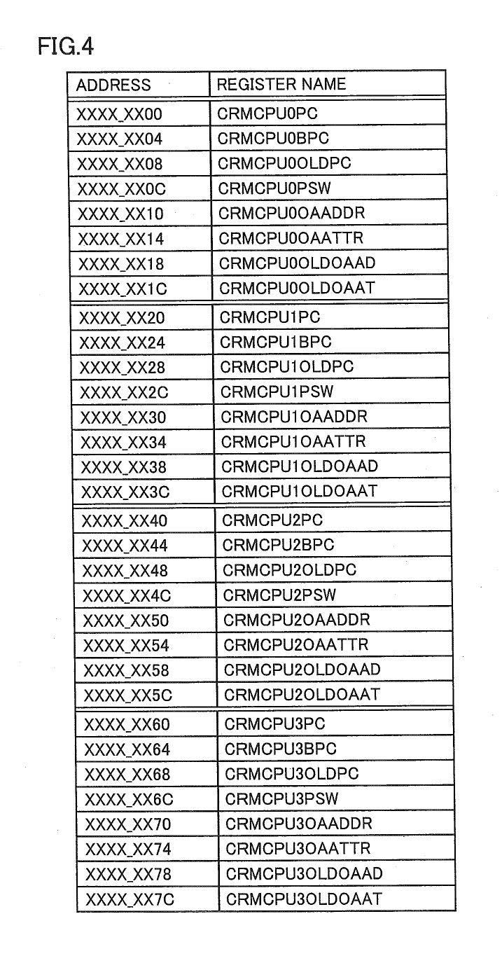

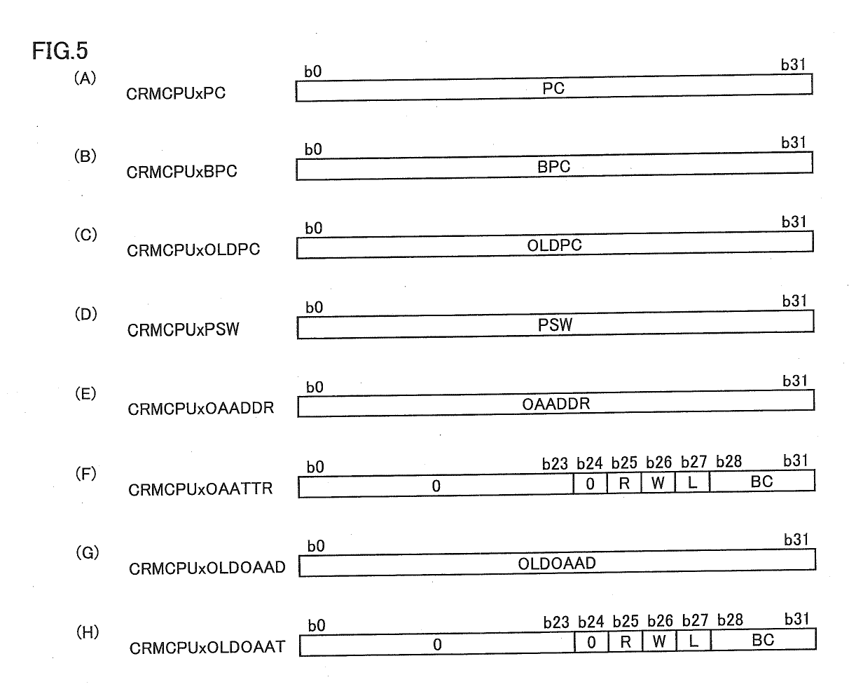

Details of a configuration of each of registers 61 to 68 constituting set of monitoring registers 60 will be described later with reference to FIGS. 4 and 5. Here, values of registers 61, 63, 64, 65, and 66 are updated every clock cycle, whereas registers 62, 67, and 68 are not necessarily updated every clock cycle.

Register 62 holds a value of the execute program counter before update only when a value of the execute program counter (PC) is updated. For this purpose, flip-flop 52 is provided in a stage preceding register 62 and a comparator circuit 55 is provided. Comparator circuit 55 compares a value of an execute program counter held in flip-flop 51 with a new value of the execute program counter input every clock cycle. When these values match with each other, comparator circuit 55 outputs “0”, and when they do not match, it outputs “1”. Flip-flop 52 holds a value of the execute program counter every clock cycle, and updates a value of register 62 by outputting the held value of the execute program counter to register 62 only when the output from comparator circuit 55 is “1” (WE=“1”).

Only when attributes of an operand address and an operand access are updated, registers 67, 68 hold values before update respectively. For this purpose, flip-flop 54 is provided in a stage preceding registers 67, 68. Flip-flop 54 holds respective attributes of an operand address and an operand access every clock cycle. Flip-flop 54 updates contents in registers 67, 68 by outputting the attributes of the held operand address and operand access to registers 67, 68, respectively, when the bus acknowledge signal (DCC1HOAACK) is activated.

It is noted that set of monitoring registers 60 does not necessarily have to be provided within CPU core 10_3, however, in order to shorten a signal path for transmitting internal information of CPU 0, it is desirably provided within CPU core 10_3 as shown in FIG. 2. If set of monitoring registers 60 is provided outside CPU 3 and set of monitoring registers 60 and CPU 3 are connected to each other through bus 20, CPU 3 cannot access set of monitoring registers 60 when bus 20 hangs up. Alternatively, in order to avoid this problem, set of monitoring registers 60 and CPU 3 are connected to each other through a number of dedicated signal lines.

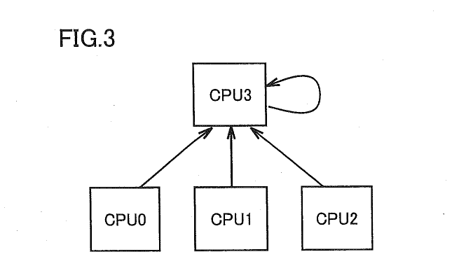

FIG. 3 is a conceptual diagram for illustrating signal transmission between CPU cores in a microcomputer chip including 4 CPUs, and shows an example where a path for reading an internal state of each CPU is in a tree configuration.

Referring to FIG. 3, each piece of internal information of CPUs 0, 1, 2 is transferred to the set of monitoring registers provided in CPU 3. In addition, a set of monitoring registers for holding internal information of CPU 3 itself is desirably provided within CPU 3. Since the set of monitoring registers provided in CPU 3 is mapped in the memory space of CPU 3, internal information of these CPUs 0 to 3 can collectively be output to the outside of the CPUs by using a memory damp function provided in a general debugger. Namely, simply by mapping a desired observation target in the memory space of CPU 3, the memory damp function can be used to observe these observation targets from the outside of the microcomputer chip. Modification on a debugger side such as an emulator or an emulator firm is not necessary.

It is noted that, in actually debugging a program, in an initial stage, only CPU 0 to CPU 2 desirably operate a program with CPU 3 being dedicated for monitoring. Then, it is efficient that, in a stage where debugging has proceeded to some extent, all of CPUs 0 to 3 are used to operate the program.

[Details of Set of Monitoring Registers]

FIG. 4 is a list of the set of monitoring registers provided in CPU 3. A higher order bit “XXXX-XX” of an address shown in FIG. 4 indicates a specific address in a memory space.

FIG. 5 is a diagram for illustrating each monitoring register in FIG. 4. Referring to FIGS. 4 and 5, registers CRMCPU0PC to CRMCPU3PC (register 61 in FIG. 2) hold values of the execute program counters (PCs) of CPUs 0 to 3 (32 bits: bits b0 to b31), respectively.

Registers CRMCPU0BPC to CRMCPU3BPC (register 63 in FIG. 2) hold values of the backup program counters (BPC) of CPUs 0 to 3 (32 bits), respectively.

Registers CRMCPU0OLDPC to CRMCPU3OLDPC (register 62 in FIG. 2) hold values immediately before the execute program counters of CPUs 0 to 3 change to current values (OLDPC: 32 bits), respectively. In a case where a CPU hangs up, a command preceding by one or more the currently executed command is often a cause thereof, and in addition, in order to obtain program flow, it is important to hold an execute program counter history covering one or more stages.

Registers CRMCPU0PSW to CRMCPU3PSW (register 64 in FIG. 2) hold values of program status words (PSW) of CPUs 0 to 3 (32 bits), respectively.

Registers CMRCPU0OAADDR to CRMCPU3OAADDR (register 65 in FIG. 2) hold operand access addresses output from CPUs 0 to 3 (OAADDR: 32 bits), respectively.

Registers CRMCPU0OAATTR to CRMCPU3OAATTR (register 66 in FIG. 2) hold attributes of operand accesses output from CPUs 0 to 3, respectively (request R, write W, lock L, byte control BC). Specifically, a case of R=0 represents absence of request and a case of R=1 represents presence of a request. A case of W=0 represents a read request and a case of W=1 represents a write request. A value for W is valid only when R=1. A case of L=0 indicates not during a lock period or during an unlock request, and a case of L=1 indicates during a lock period or during a lock request. Byte control BC is a 4-bit byte control signal, and it is valid only when R=1.

Registers CRMCPU0OLDOAAD to CRMCPU3OLDOAAD (register 67 in FIG. 2) hold values of operand access addresses (OLDOAAD) (32 bits) preceding by one the current operand access addresses output from CPUs 0 to 3, respectively. In a case where a CPU hangs up, an operand access preceding by one or more the currently executed operand access is often a cause thereof. Therefore, it is important to hold an operand access address history covering one or more stages.

Registers CRMCPU0OLDOAAT to CRMCPU3OLDOAAT (register 68 in FIG. 2) hold operand access attributes preceding by one the current operand access attributes (request R, write W, lock L, byte control BC) output from CPUs 0 to 3, respectively. In a case where a CPU hangs up, an operand access preceding by one or more the currently executed operand access is often a cause thereof. Therefore, it is important to hold an operand access attribute history covering one or more stages.

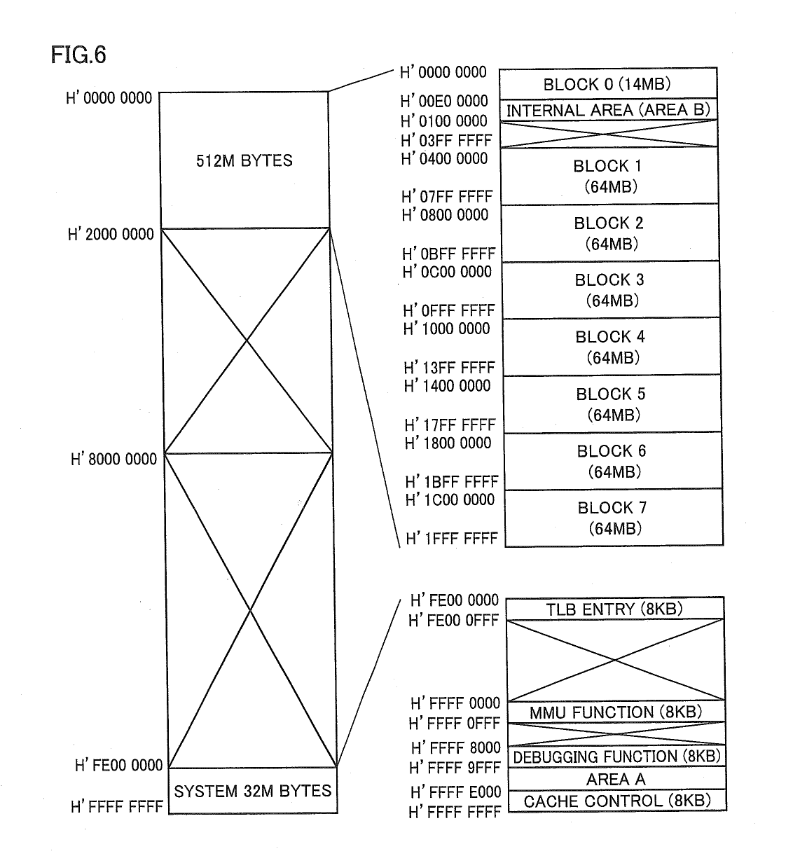

FIG. 6 is a diagram showing one example of an address map of CPU 3 in FIG. 1.

Referring to FIG. 6, 512 M bytes from H′0000_{—}0000 to H′1FFF_FFFF are divided into blocks. An external area of 16 MB is allocated to each block. The external area makes an access through external bus interface 23 in FIG. 1. The internal memory and peripheral IO 22 in FIG. 1 are allocated to an internal area.

Thirty-two M bytes from H′FE00_{—}00000 to H′FFFF_FFFF are allocated to a system area.

The set of monitoring registers in FIG. 4 can be allocated, for example, to an empty area not allocated to other resources, such as an area A within a system area or an area B which is a part of an internal area of 2 M bytes.

[Description of Debugging Method]

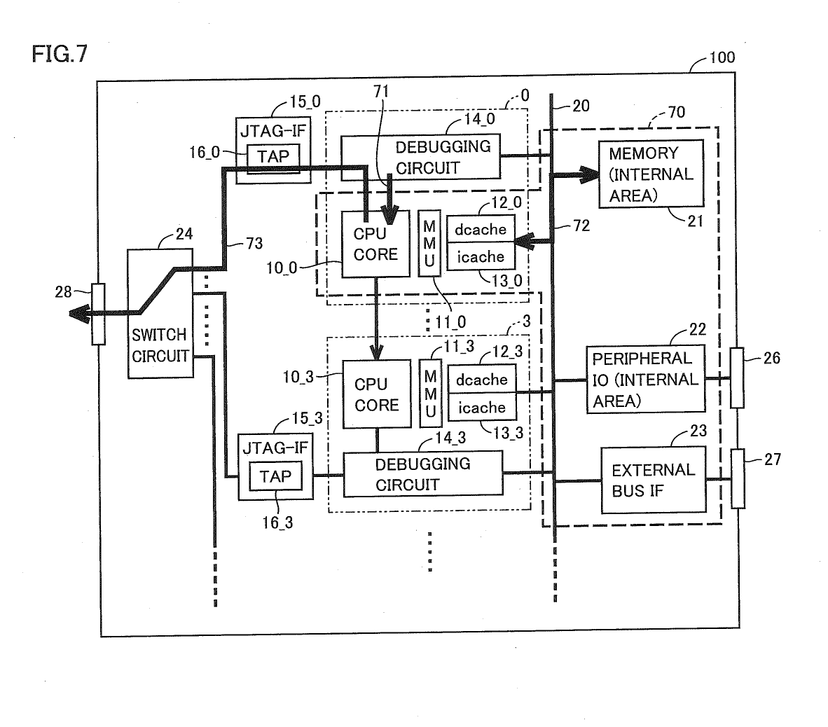

FIG. 7 is a diagram for illustrating an on-chip debugging method in a case where CPU 0 has not hung up.

Referring to FIG. 7, CPU core 100 itself as well as internal memory 21, input and output interface 22, and external bus interface 23 accessible from CPU core 10_0 are defined as a debugging target 70.

Initially, a control code reaches debugging circuit 14_0 from the outside of microcomputer chip 100. In a case where the control code in this case is an operand access, debugging circuit 14_0 issues such a command as load or store to CPU core 10_0 (a reference numeral 71 in FIG. 7). Upon receiving the command from debugging circuit 14_0, CPU core 10_0 accesses, for example, internal memory 21 which is an observation target (a reference numeral 72 in FIG. 7). A result of memory access by CPU core 10_0 is output to the outside through debugging circuit 14_0, JTAG interface 15_0, and JTAG port 28 (a reference numeral 73 in FIG. 7).

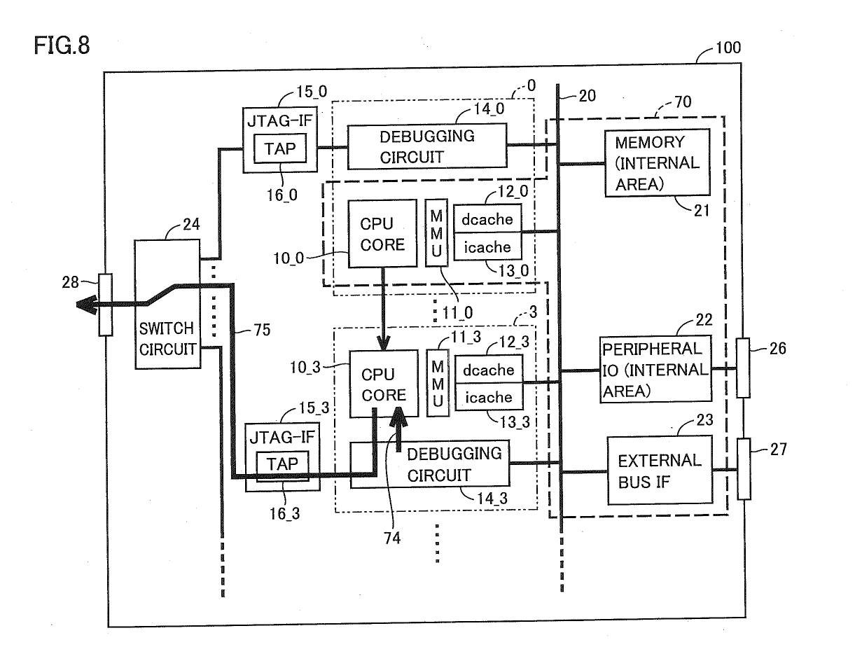

FIG. 8 is a diagram for illustrating an on-chip debugging method in a case where CPU 0 has hung up.

A cause of inability of a CPU core to operate is considered as a bus access path being in use in spite of supply of a command to a CPU. In this case, the CPU cannot complete preceding operand access processing and hangs up. As another cause, a case of hang-up by a bug in a CPU core or the like is considered. When CPU 0 hangs up, information cannot be output to the outside from a debugging target system 70.

As already described, in microcomputer chip 100 in the first embodiment, information representing an internal state of CPU 0 is transferred to the set of monitoring registers within CPU core 10_3. Then, the set of monitoring registers is mapped in the memory space of CPU 3. Therefore, debugging circuit 14_3 issues a command for loading contents in the set of monitoring registers to CPU 3 (a reference numeral 74 in FIG. 8), so that information on hung-up CPU 0 can be output to the outside through JTAG interface 15_3 and JTAG port 28 (a reference numeral 75 in FIG.

8). Consequently, debugging can be carried out more readily than in the conventional example.

<Second Embodiment>

In the first embodiment, an example where the path for reading an internal state is in a tree configuration such that information representing internal states of CPUs 0 to 3 is entirely transferred to the set of monitoring registers provided in CPU 3 has been shown. In a second embodiment, a variation of the path for reading an internal state of each CPU will be described. Since a path for reading an internal state of each CPU can freely be determined independently of a form of a connection network of CPUs. (each topology of an on-chip bus and network-on-chip), an on-chip debugging method according to this invention is suited to an on-chip multi-processor. For example, even when a connection network is in a mesh configuration based on network-on-chip, a path for reading an internal state of each CPU can be simplified by adopting a tree structure.

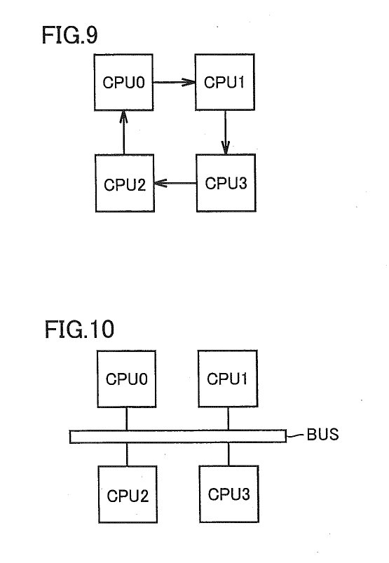

FIG. 9 is a diagram showing an example where a path for reading an internal state of each CPU in a microcomputer chip including 4 CPUs is in a ring configuration. In the example shown in FIG. 9, internal information of CPU 0 is transferred to a set of monitoring registers provided in CPU 1, internal information of CPU 1 is transferred to a set of monitoring registers provided in CPU 3, internal information of CPU 3 is transferred to a set of monitoring registers provided in CPU 2, and internal information of CPU 2 is transferred to a set of monitoring registers provided in CPU 0. Namely, a path for reading an internal state of each CPU is in a ring configuration.

FIG. 10 is a diagram showing an example where a path for reading an internal state of each CPU in a microcomputer chip including 4 CPUs is in a bus configuration. In the example shown in FIG. 10, internal information in each of CPUs 0 to 3 is transferred to a set of monitoring registers provided in at least one of CPUs 0 to 3 via a bus (BUS).

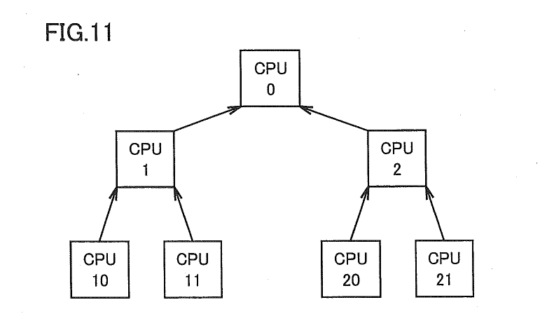

FIG. 11 is a diagram showing an example where a path for reading an internal state of each CPU in a microcomputer chip including 7 CPUs is in a tree configuration. FIG. 11 shows an example where a path for reading an internal state of each CPU is in a tree configuration. Specifically, each piece of internal information of CPUs 10, 11 is transferred to a set of monitoring registers provided in CPU 1, each piece of internal information of CPUs 20, 21 is transferred to a set of monitoring registers provided in CPU 2, and each piece of internal information of CPUs 1, 2 is transferred to a set of monitoring registers provided in CPU 0.

It should be understood that the embodiments disclosed herein are illustrative and non-restrictive in every respect. The scope of this invention is defined by the terms of the claims, rather than the description above, and is intended to include any modifications within the scope and meaning equivalent to the terms of the claims.

### Reference Signs List

0 to 3 CPU; 10 core circuit (CPU core); 11 memory management unit; 12 data cache; 13 command cache; 14 debugging circuit; 15 JTAG interface; 20 internal bus; 21 internal memory; 22 input and output interface; 23 external bus interface; 24 switch circuit; 26, 27 input and output port; 28 JTAG port; 30 set of special registers; 31 execute program counter; 33 program status word; 41 to 54 flip-flop; 60 set of monitoring registers; and 100 microcomputer chip.

1. A semiconductor device, comprising:
first and second central processing units; and
a set of monitoring registers provided inside or outside said second central processing unit, for receiving information representing an internal state of said first central processing unit transferred from said first central processing unit during execution of a program and holding the transferred information,
said set of monitoring registers being mapped in a memory space of said second central processing unit.

2. The semiconductor device according to claim 1, wherein
said second central processing unit includes:
a core circuit executing a program; and
a debugging circuit causing said core circuit to output a value of said set of monitoring registers mapped in the memory .space and outputting the output value of said set of monitoring registers to outside of said semiconductor device through a dedicated port, when a specific command is received from the outside of said semiconductor device through the dedicated port.

3. The semiconductor device according to claim 1, wherein
said first central processing unit includes a core circuit executing a program,
said core circuit has a set of special registers used during execution of the program, and
a value of said set of special registers is transferred to said set of monitoring registers as information representing the internal state of said first central processing unit.

4. The semiconductor device according to claim 3, wherein
said set of special registers includes an execute program counter.

5. The semiconductor device according to claim 3, wherein
said set of special registers includes a register holding an operand address.

6. The semiconductor device according to claim 1, wherein
said first central processing unit includes a memory management unit converting between a virtual address and a physical address, and
information on the physical address brought in correspondence with the virtual address by said memory management unit is transferred to said set of monitoring registers as information representing the internal state of said first central processing unit.

7. The semiconductor device according to claim 1, wherein
a value of one monitoring register or a plurality of monitoring registers which is/are a part of said set of monitoring registers is updated by the information transferred from said first central processing unit every clock cycle.

8. The semiconductor device according to claim 1, further comprising one or more holding circuits provided in a stage preceding one or more monitoring registers, respectively, which are a part of said set of monitoring registers, wherein
each of said one or more holding circuits holds new information transferred from said first central processing unit every clock cycle, and
each of said one or more holding circuits updates, only when a value of held information has changed, a value of a corresponding monitoring register with information before change.

9. The semiconductor device according to claim 1, further comprising one or more holding circuits provided in a stage preceding one or more monitoring registers, respectively, which are a part of said set of monitoring registers, wherein
each of said one or more holding circuits holds new information transferred from said first central processing unit every clock cycle, and
each of said one or more holding circuits updates contents held in a corresponding register with held information while a specific signal received from said first central processing unit is activated.
